(19) United States
(12) Patent Application Publication
(10) Pub. No.: US 2004/0154212 A1
(43) Pub. Date: Aug. 12, 2004

(54) Jig fish lure

(76) Inventor: Eric A. Harrell, Piedmont, SC (US)

Correspondence Address: BROWN & MICHAELS, PC, 400 M & T BANK BUILDING, 118 NORTH TIOGA ST, ITHACA, NY, 14850, US

(21) Appl. No.: 10/637,786

(22) Filed: Aug. 8, 2003

Related U.S. Application Data
(60) Provisional application No. 60/445,887, filed on Feb. 6, 2003.

(51) Int. Cl. A01K 85/00

(52) U.S. Cl. 43/42.39

(57) ABSTRACT

A jig fish lure having a body and a hook attached to the body. An eye allows attachment of fishing line to the lure. The eye is located to the rear of the body, either in a recess or cavity or behind the body itself, so that fish line knotted to the eye is shielded by the body of the lure. The fishing line is led from the front of the body to the eye in the rear through a passage through the body. Weed guards may optionally be provided.

### REFERENCE TO RELATED APPLICATIONS

This application claims an invention which was disclosed in Provisional Application No. 60/445,887, filed Feb. 6, 2003, entitled “JIG FISH LURE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of fish lures. More particularly, the invention pertains to a jig that is less susceptible to be caught on underwater debris.

2. Description of Related Art

The sport of bass fishing is gaining momentum across the Nation as the #1 participatory sport in America. The sports exposure is multifaceted and includes; National TV, magazines, and tournaments, which are supported by some of the largest companies in America. Bass fishing is currently a 4 billion dollar per year industry and over 60 million Americans participate in it.

The principal anatomy of the bass fishing jig currently sold on today's market is similar among competing companies: simply, there is a hook with an eye hole at the front end. Around this front end (usually called the “head” of the jig) different metals ire molded to add weight to the lure.

All jigs on the market today have the eye of the hook located at the front, therefore, the knot is tied at the front of the lure (this is the area on a jig that is most susceptible to getting caught on weeds/rocks or wood).

For those jigs used in weeds or around wood (heavy cover) a “weed guard” is used to prevent the hook from getting “snagged” or caught on surrounding “cover.” The vast majority of weed guards consist of a few dozen thin pieces of hard plastic, which project from the head of the jig and stop just above the hook point. The jig almost always has a “skirt” that extends back from the jig head to the bottom of the hook.

### SUMMARY OF THE INVENTION

The jig fish lure of the invention has a body and a hook attached to the body. An eye allows attachment of fishing line to the lure. The eye is located to the rear of the body, either in a recess or cavity or behind the body itself, so that fish line knotted to the eye is shielded by the body of the lure. The fishing line is led from the front of the body to the eye in the rear through a passage through the body. Weed guards may optionally be provided.

### BRIEF DESCRIPTION OF THE DRAWING

FIG. 1 shows a side view of the present invention.

FIG. 2 shows a top view of the present invention.

FIG. 3 shows a bottom view of the present invention.

FIG. 4 shows a top view of another embodiment of the invention.

FIG. 5 shows a top view of another embodiment of the invention.

FIG. 6 shows a side view of the embodiment of FIG. 5.

FIG. 7 shows a side view of another embodiment of the invention.

### DETAILED DESCRIPTION OF THE INVENTION

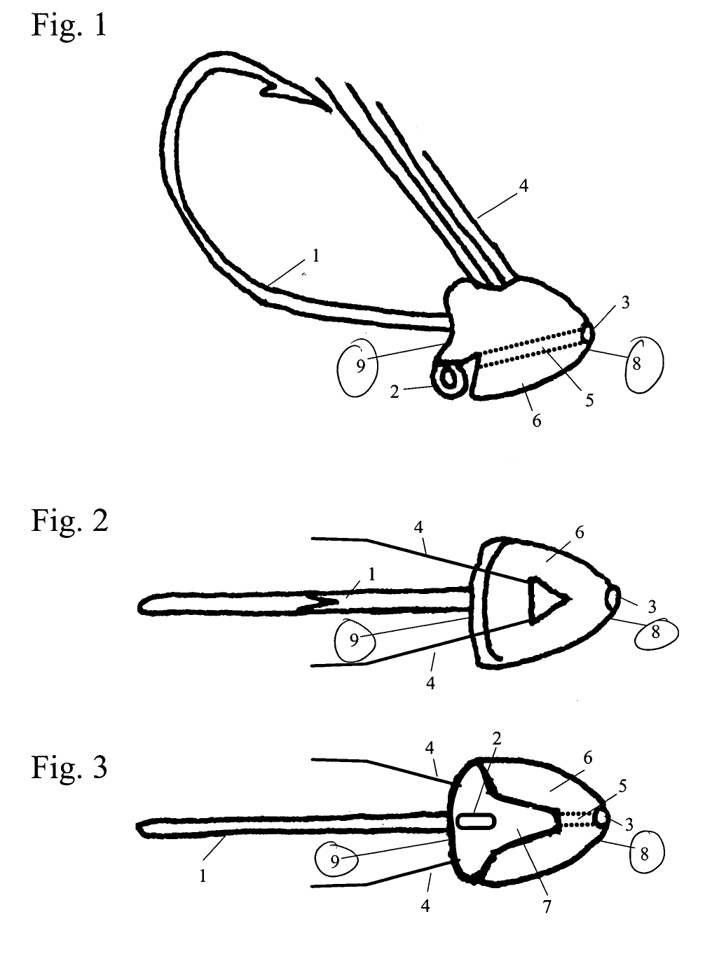

FIGS. 1 to 3 show the fish lure of the invention. The lure has a body (6) which is preferably solid, and can be made of plastic, metal, wood or some other material as is known to the art of making lures. A hook (1) extends from the rear of the body (6). The form of the hook (1) is conventional and may vary within the teachings of the invention. Optionally, one or more weed guards (4) may be provided to minimize the likelihood that the lure will catch on weeds—four weed guards are shown in FIG. 1, two in FIGS. 2 and 3, but it will be understood that the number and arrangement of weed guards may vary, and they may be omitted entirely.

As is conventional in fish lures, an eye (2) is provided to which the fishing line may be tied. However, in the lure of the invention, and in contrast to the prior art lures, the eye (2) is located at the rear of the body (6). In the embodiment of the lure shown in FIGS. 1-6, the eye (2) is in a recess or cavity (7) in the rear of the body (6) which provides protection for the knot tied to the eye (2). This will essentially protect the knots strength and hide it from getting caught on any underwater cover (weeds, rocks, wood).

The fishing line is routed through a hole (3) at the front of the body (6), through a tunnel (5) into the cavity (7), and then tied to the eye (2) at the rear of the body.

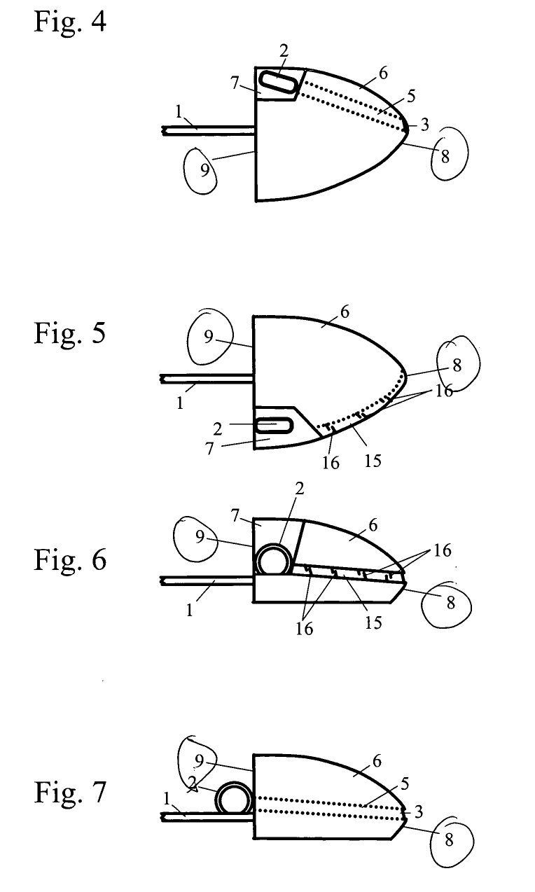

The body (6) of the lure shown in FIGS. 4 through 7 is a simpler form than that shown in FIGS. 1-3, having a flat bottom and simple curved top. The exact form of the body may be chosen from among the wide variety of designs known to the art, within the teachings of the invention.

FIG. 4 shows an alternate embodiment of the invention, in which the eye (2) and cavity are offset to one side of the body (6), instead of being centered as shown in the embodiment of FIGS. 1-3.

FIGS. 5 and 6 show another alternate embodiment of the invention, in which the eye (2) is offset to the side of the body (6) as in FIG. 4. In this embodiment, the fishing line tunnel is replaced by a groove (15) recessed into the side of the lure body (6). If desired, small clips (16) may be provided in the groove (15) to retain the line. Alternatively, the groove may be shaped with a lip to retain the line. This embodiment would be easier to attach the fishing line to than the embodiments using a tunnel through which the line would have to be threaded.

FIG. 7 shows an alternative embodiment which omits the cavity, and places the eye (2) behind the body (6). The tunnel (5) leads from the hole (3) to the back of the body (6) adjacent the eye (2).

It will be noted that the embodiment of FIGS. 4-7 have been shown with the eye above the shaft of the hook, and the embodiment of FIGS. 1-3 has the eye under the shaft. It will be understood that it could also be horizontally to one side of the shaft or the other as well, within the teachings of the invention. The eye of the hook may be made either bending the hook back on itself or having a separate eye welded/molded into place.

Therefore, the design of the jig will allow the line to pass through a tunnel at the front of the jig and be tied it the back of the lure. Meanwhile the knot will be hidden inside the cavity of the jig and/or shielded by the body of the lure. This will make the jig less susceptible to getting caught on any underwater cover (weeds, rocks, wood).

Accordingly, it is to be understood that the embodiments of the invention herein described are merely illustrative of the application of the principles of the invention.

What is claimed is:

1. A jig fish lure comprising:
a) a body having a front and a rear;
b) a hook extending from the rear of the body;
c) an eye for attaching fishing line, mounted at the rear of the body and shielded by the body;
d) a passage extending from the front of the body to the rear of the body adjacent to the eye.

2. The jig fish lure of claim 1, in which the eye is mounted in a cavity formed in the body, extending to the rear of the body.

3. The jig fish lure of claim 2, in which the cavity is centered relative to a centerline of the body.

4. The jig fish lure of claim 2, in which the cavity is offset to a side of a centerline of the body.

5. The jig fish lure of claim 4, in which the passageway is a groove formed in a side of the body.

6. The jig fish lure of claim 5, further comprising a plurality of clips located in the groove for retaining fishing line in the groove.

7. The jig fish lure of claim 1, in which the passageway is a tunnel through the body.

8. The jig fish lure of claim 1, further comprising at least one weed guard attached to the body and shielding the hook.
